(19) United States
(12) Patent Application Publication
(10) Pub. No.: US 2012/0251991 A1
(43) Pub. Date: Oct. 4, 2012

(54) Peripheral Probe with Six Degrees of Freedom Plus Compressive Force Feedback

(76) Inventors: Eric Savitsky, Malibu, CA (US); Dan Katz, Encino, CA (US); Gabriele Nataneli, Beverly Hills, CA (US)

(21) Appl. No.: 13/481,698

(22) Filed: May 25, 2012

Related U.S. Application Data
(63) Continuation-in-part of application No. 13/243,758, filed on Sep. 23, 2011.
Application No. 13/243,758 is a continuation of application No. 11/720,515, filed on May 30, 2007, now abandoned.
(60) Provisional application No. 60/631,488, filed on Nov. 30, 2004.

(51) Int. Cl. G09B 23/28

(52) U.S. Cl. 434/262

(57) ABSTRACT

An enhanced six degree of freedom spatial inertial measuring device capable of measuring translational movement along three orthogonal axes and rotational movement about the same, and in addition, being capable of measuring compression along at least one orthogonal axis. The device serves to provide adequate control for software applications where inertial tracking and compressive force feedback along at least one axis is desired. A probe, which accurately simulates ultrasound imaging, and therefore functions as a teaching tool is one such application.

### CROSS-REFERENCES TO RELATED APPLICATIONS

This patent application is a continuation-in-part and claims the benefit of U.S. patent application Ser. No. 13/243,758 filed Sep. 23, 2011 for Multimodal Ultrasound Training System, which is a continuation of U.S. patent application Ser. No. 11/720,515 filed May 30, 2007 for Multimodal Medical Procedure Training System, which is the national stage entry of PCT/US05/43155, entitled “Multimodal Medical Procedure Training System” and filed Nov. 30, 2005, which claims priority to U.S. Provisional Patent Application No. 60/631,488, entitled Multimodal Emergency Medical Procedural Training Platform and filed Nov. 30, 2004. Each of those applications is incorporated here by this reference.

This patent application claims the benefit of U.S. Provisional Application Ser. No. 61/491,126 filed May 27, 2011 for Data Acquisition, Reconstruction, and Simulation; U.S. Provisional Application Ser. No. 61/491,131 filed May 27, 2011 for Data Validator; U.S. Provisional Application Ser. No. 61/491,134 filed May 27, 2011 for Peripheral Probe with Six Degrees of Freedom Plus 1; U.S. Provisional Application Ser. No. 61/491,135. filed May 27, 2011 for Patient-Specific Advanced Ultrasound Image Reconstruction Algorithms; and U.S. Provisional Application Ser. No. 61/491,138 filed May 27, 2011 for System and Method for Improving Acquired Ultrasound-Image Review. Each of those applications is incorporated here by this reference.

### TECHNICAL FIELD

The present invention relates generally to the field of motion sensing devices, and more specifically, to an enhanced six degree of freedom spatial inertial measuring device, the enhancement being the incorporation of compressive force feedback along at least one translational axis. The exemplary embodiment is particularly directed towards a hand-held probe useful for teaching doctors and other medical personnel the proper techniques for conducting ultrasound imaging. The disclosed technology may be readily incorporated in any other device where real-time tracking of the spatial orientation of an object is desired along with compressive force feedback along one or more translational axes.

### BACKGROUND ART

Current state of the art devices include a variety of three and six degree of freedom inertial motion sensors. Typical three degree of freedom devices include accelerometers for measuring linear accelerations along X, Y, and Z translational axes (also known as displacement axes). Six degree of freedom devices add gyroscopes for measuring the angular velocities or rotations about those same axes. It is also known in the art to use a compass in combination with gyroscopes to correct for rotational drift.

Suitable accelerometers for measuring axial translations and converting those translations into electrical signals are known in the art. Piezoelectric, piezoresistive, and capacitive components have been commonly used to convert linear mechanical motion into an electrical signal. Modern accelerometers are often micro electro-mechanical systems or MEMS devices. MEMS devices are electro-mechanical devices that typically range from about 20 micrometers to about 1 millimeter in size for a completed device. MEMS accelerometers are relatively inexpensive and are thus well-suited for use in motion sensors.

Numerous types of gyroscopes have been developed over the years. Gyroscope designs fall into two general categories, i.e. rotating mass gyroscopes and vibrating structure gyroscopes. Vibrating structure gyroscopes are simpler and cheaper than conventional rotating mass gyroscopes and are of similar accuracy. In recent years, vibrating structure gyroscopes manufactured with MEMS technology have become widely available. Like MEMS accelerometers, MEMS gyroscopes are of relatively low cost and are available in many configurations and thus are well-suited for use in multi-degree of freedom motion sensors. MEMS compasses for use with MEMS gyroscopes are also available and known in the art.

While the prior art has advanced to the point that modest cost, six degree of freedom motion sensors are now available and are commonly used in motion stabilization cameras, spacecraft, and aircraft, among other devices, compressive force feedback along a translational axis is lacking from the prior art inertial motion sensors. In addition to six degree of freedom tracking information, compressive force feedback would be a highly desirable feature in medical applications where devices are physically in contact with the body of a patient. Compressive force detection and feedback in particular, would provide doctors with audio or visual indications of whether an appropriate amount of force or pressure is being applied to a patient undergoing ultrasound imaging.

### DISCLOSURE OF INVENTION

The present invention is an enhanced six degree of freedom spatial inertial measuring device in the form of an ultrasound probe. The device is capable of measuring translational movement along three orthogonal axes and rotational movement about those same axes. Included in the device is a compass (preferably a MEMS digital compass) to correct for rotational drift. In addition, the device is capable of measuring compression along at least one translational axis, which makes the device particularly well-suited for use in training medical personnel in the use of ultrasound imaging techniques.

The primary purpose of the device is to provide adequate control for software applications, especially in the field of ultrasound simulation, where the added mode of compressive sensing is necessary to accurately simulate the real task of imaging parts of a human body with an ultrasound probe. The device is built in such a manner that it may be encased in various types of enclosures that mimic the shape and tactile feel of actual ultrasound probes. The enhanced motion sensor of the present invention is not limited to use in ultrasound probes but may be used in any other device where compressive force detection and feedback is desired.

### BRIEF DESCRIPTION OF DRAWINGS

FIG. 1 is a block diagram of the six degree of freedom with force feedback system of the present invention.

FIG. 2 is a schematic diagram of the design of a printed circuit board suitable for implementing the six degree of freedom with force feedback system of the present invention.

FIG. 3 is a perspective view of the enclosure of an ultrasound transducer suitable for use with the system of the present invention.

### BEST MODE FOR CARRYING OUT THE INVENTION

The present invention will now be described more fully with reference in the accompanying drawings to the exemplary embodiment. The exemplary embodiment in this instance refers to a six degree of freedom (DOF) spatial sensor that incorporates compressive force detection and feedback along at least one translational axis. This configuration is referred to in this application as a 6+1 DOF probe. The invention may be embodied in many different forms and should not be construed as being limited to the exemplary embodiment set forth. Those skilled in the art will readily understand that additional strain gauges or other sensors capable of detecting compressive force may be added to provide compressive force feedback on additional translational axes. The exemplary embodiment is provided so that this disclosure will be thorough, complete, and fully convey the scope of the invention to those skilled in the art.

The 6+1 DOF probe 10 is a motion-sensing peripheral device intended to interface with a computer 22 to provide real-time tracking of the 6+1 DOF probe 10 in three-dimensional space. Various embodiments of these sensor components may include inertial, magnetic, optical, and MEMS sensors.

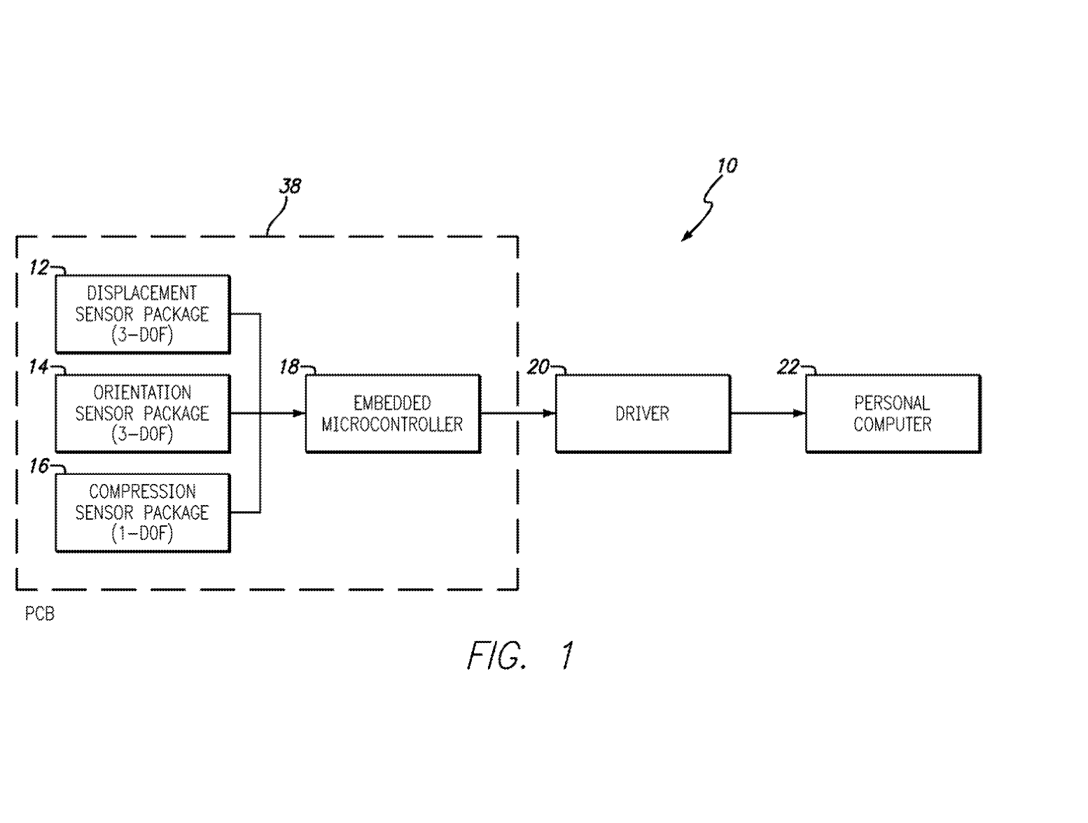

With reference to FIG. 1, a block diagram of the 6+1 DOF probe 10 is shown. The system includes a displacement sensor package 12, a gyroscope or orientation sensor package 14, and a single axis compression sensor 16. The displacement sensor package 12 and the orientation sensor package 14 provide position input in the form of electrical signals to an embedded microcontroller 18. The compressive force sensor 16, or force detection sensor, likewise provides force input in the form of an electrical signal to the microcontroller 18. The 6+1 DOF probe 10 also includes a driver software package 20 which allows spatial orientation and compressive force data from the microcontroller 18 to be displayed on a computer 22.

The core of the present invention includes the 3-axis displacement sensing package 12, the 3-axis orientation sensing package 14, and the addition the compression sensor 16. The aforementioned displacement sensor package 12 and the orientation sensor package 14 can be built using three independent single axis sensors arranged in an orthogonal configuration or may come in a single package that combines multiple sensing components into a single unit.

The displacement or translation sensing package 12 comprises accelerometers capable of measuring translations (relative movement) along each of three orthogonal axes. Many types of accelerometers are suitable for use in the displacement sensor package 12, such as piezoelectric, piezoresistive, and capacitive type sensors. But MEMS accelerometers are preferred for their small size and low cost. MEMS accelerometers are available as single axis devices (in which case one MEMS accelerometer is required for each axis) and as integrated packages containing three accelerometers.

The rotation or orientation package 14 is a package containing three gyroscopes, perhaps with a magnetometer or compass 15 for correcting rotational drift. Many types of vibrating structure type gyroscopes, as well as magnetometers or compasses are available and known in the art. In the exemplary embodiment, MEMS gyroscopes and MEMS compasses are preferred for their small size and because MEMS gyroscopes are available both in single axis of rotation devices and as integrated devices which can provide complete angular velocity information about three orthogonal axes as well as correct for rotational drift via an included MEMS compass. In some embodiments, gyroscopes, accelerometers, and other components such as temperature and barometric pressure sensors may be used in tandem to improve the sensing accuracy by exploiting techniques of sensor fusion.

In the exemplary embodiment, the compressive force sensor 16 is a uniaxial wire strain gage for providing compressive force information along a single translational axis. However, the invention is not limited to providing compressing force information along a single axis and further is not limited to a uniaxial strain gauge. In applications where compressive force information is desired along multiple axes, strain gauge rosettes or other multiple strain gauge arrangements may be provided so that compressive force feedback is available on any desired axis.

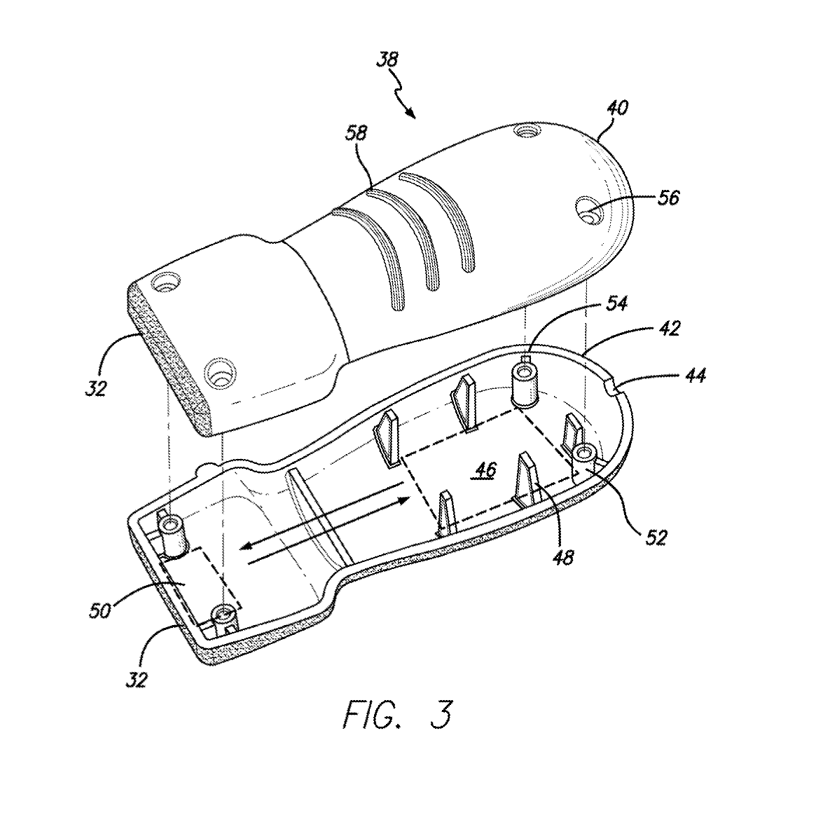

The sensing components of the 6+1 DOF probe 10 must be small enough to fit into a handheld enclosure 38. (See FIG. 3.) Common solutions for measuring translational displacement within a small footprint include capacitive and piezoelectric accelerometers and MEMS accelerometers, but other displacement sensors that rely on other operating principles may be used as well. Orientation is typically measured using vibrating structure type gyroscopes, such as MEMS gyroscopes, in conjunction with a MEMS digital compass to correct for rotational drift.

In the technical literature, several small-scale solutions also exist for measuring compression. The most common of which are strain gauges, which are electronic components that that correlate mechanical stress to a change in electrical resistance. All the core electronics and wiring of the device are installed on a printed circuit board (PCB) 36 with the exception of the compression sensor or strain gauge 16, which, in the exemplary embodiment, is remotely located from the PCB 36.

For use in the 6+1 DOF probe 10, the compression sensor 16 is remotely located, and ideally, will be positioned at the point where the 6+1 DOF probe 10 makes contact with the patient to provide for the most accurate readings of the force or pressure being applied to the surrounding tissues of the patient.

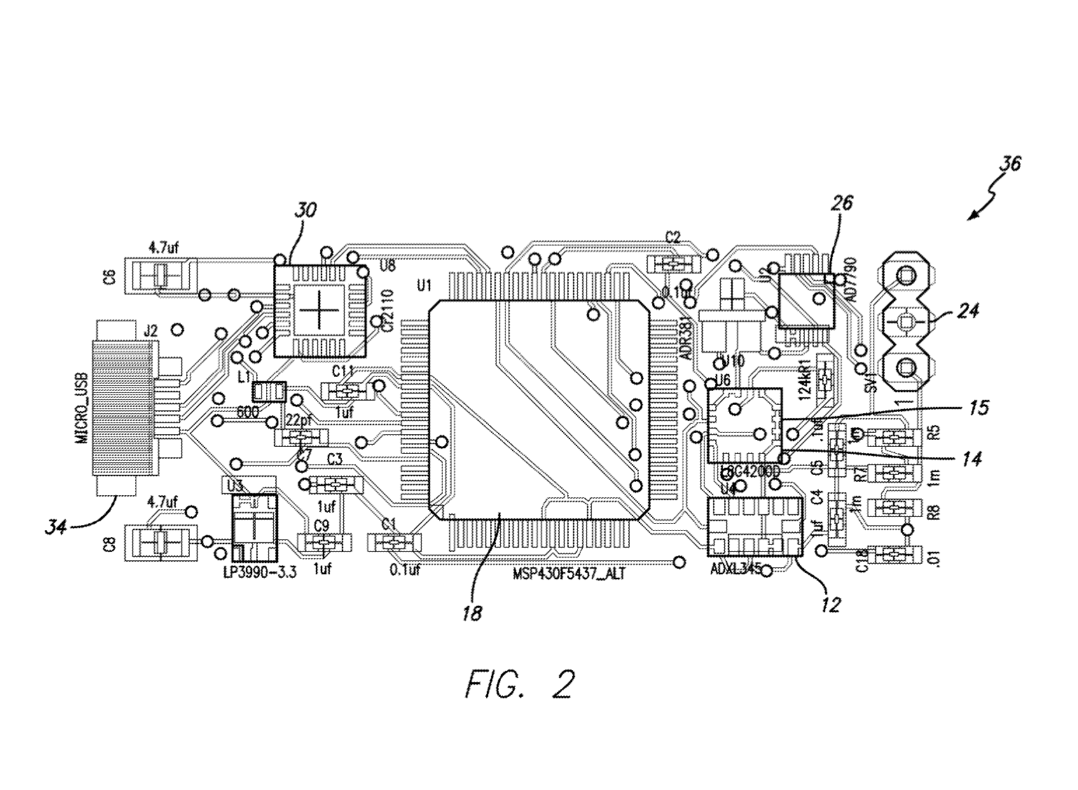

With reference to FIG. 2, an exemplary embodiment of the layout of the PCB 36 is shown. In the exemplary design, low-level signals from the sensing components, i.e. translation sensors 12, orientation sensors 14, compass 15, and compression sensor 16, are fed into an analog-to-digital converter 26 as needed, and are then transmitted to a digital signal processor or micro-controller 18 for further processing. The processed signal is then forwarded into a personal computer 22 through a USB cable or serial input connection 34. The 6+1 DOF probe 10 is not limited to a USB connection but may use any data protocol for wire transmission of data and likewise may wirelessly communicate with the computer 22 via existing and future wireless communication protocols.

It is anticipated that USB communication between the 6+1 DOF probe 10 and the computer 22 will commonly take place via a USB cable; therefore the 6+1 DOF probe 10 may optionally be equipped with a USB controller 30 and a USB port 34, as is known in the art. Other forms of communication between the 6+1 DOF probe 10 and the computer 22, such as fiber optic cables, other electrical data transfer protocols such as firewire, and wireless communications are known in the art and may be implemented in the current invention.

Mathematical calculations are needed to convert the low-voltage sensor readings, i.e. from the translation sensors 12, orientation sensors 14, compass 15, and compressive force sensor 16, into computer readable signals indicative of spatial location. Suitable algorithms are known to those of skill in the art. The location algorithms may be executed on the device's microcontroller 18 or in the driver software 20 at the discretion of the circuit designer. Alternatively, some of the processing and filtering of signals may be performed on a separate digital signal processor (DSP) mounted on the PCB 36. The 6+1 DOF probe 10 includes a programming port 24 in electrical communication with the microcontroller 18 for loading and updating the necessary algorithms. The driver software provides computer readable inputs to a simulation program resident on the computer 22. A companion simulation program (not shown) visually displays the probe's location on the human body, as well as the compressive force being applied to the simulated tissue structures.

In the exemplary embodiment, the 6+1 DOF probe 10 will be used in conjunction with the companion ultrasound training software to recreate the experience of manipulating a real ultrasound probe in a simulated environment. The motion of the 6+1 DOF probe 10 as provided by the sensor array, i.e. the displacement sensor package 12 and orientation sensor package 14, will cause an analogous motion of a similarly shaped virtual probe on the screen of the computer 22. Thus the 6+1 DOF probe 10 will be used as a controller for navigating simulated medical data in the same manner as a real ultrasound probe is used to investigate the anatomy of a real body.

The pressure sensor 16 of the 6+1 DOF probe 10 provides compressive force feedback to the user via an audio or visual signaling means. In this manner, user's of the probe can determine the proper amount of pressure to apply to a patient's body during ultrasound examination. The companion software thus provides a visual representation of medical data responding under the effect of compression in an amount that is proportionate to the pressure exerted on the 6+1 DOF probe 10 by the user. Additionally, the companion software may elect to show a visual representation of a human body being deformed under the effect of compression. In the context of ultrasound simulation, the latter functionality is crucial for adequately training users in recognizing anatomical soft tissues (especially arteries and veins) and differentiating them from other structures (especially nerves and lymph nodes).

With reference to FIG. 3, the 6+1 DOF probe 10 seeks to recreate the tactile experience of using an actual ultrasound probe. The housing 38 of the 6+1 DOF probe 10 includes an upper half 40 and a lower half 42. The lower half 42, features a PCB 36 mounting area 46. Surrounding the PCB mounting area 46 are internal braces 48 which function to protect the PCB 36 from suffering accidental damage which may occur from the probe being dropped or from other such damage as may occur in a medical facility. The lower housing is also equipped with a channel 44 for the entry of power and data lines into the housing 38 and to the PCB 36.

At one end of the lower housing is a mounting surface 50 for the strain gauge or compression sensor 16. Preferably, the mounting surface 50 is made relatively thin and readily deformable so as to increase the responsiveness and accuracy of the strain gauge or compression sensor 16. In one exemplary embodiment, the tip 32 of the housing 38 may be made of a soft material that can be easily deformed under compression thereby allowing an applied pressure to be transmitted mechanically to the compression sensor 16. In another alternative embodiment, a portion or all of the entire enclosure 38 including the compression sensor mounting surface 50 may be built of single material, with the mounting surface 50 being machined to a thickness that allows plastic strain deformation under external pressure.

If fabrication constraints make the former solutions impractical, the tip 32 of the housing 38 may be built as a separate rigid component that is kept in place by a flexible mechanism (e.g., springs or bendable fixture) that allows the tip 32 to move inwards and transmit mechanical pressure to the compression sensor 16. For embodiments using an optical solution for displacement or orientation sensing, the housing 38 may need to have additional openings to accommodate the sensor, lens assembly, and illumination components, and allow correct operation of the optical device. Similarly, alternative embodiments of the sensor assembly that employ mechanical sensors with a footprint larger that common inertial MEMS components may require special accommodations in the design a fabrication of the external enclosure.

The lower housing also includes four bosses 52 which are fitted with screw thread inserts 54. The upper and lower housings 40 and 42 are joined by means of screws which pass through the recessed clearance holes 56 in the upper housing 40 and into the thread inserts in the lower housing 42. The upper and lower housings may also be equipped with ridges 58 or like features that improve a user's ability to securely grip the housing 38.

The housing 38 is intended to have the look and feel of a real ultrasound transducer, including curvilinear, phased-array, or linear probes. The housing 38, or external enclosure, can be built with a variety of lightweight materials (e.g., plastics) and manufacturing techniques (e.g. injection molding). Plastic is used in the exemplary embodiment. The unit's plastic housing 38 may be modified based on the user's desired ultrasound transducer-type. The multiple internal braces 48 of the housing 38 secure the PCB 36 in place and prevent undesired motion of the displacement sensor package 12, the orientation sensor package 14, and the compression sensor 16.

For some applications, when translational motion is constrained to a 2D surface, a full three-axis displacement sensing assembly may not be practical or cost-effective and it may be replaced with an alternative solution for sensing displacement along only two axes. The latter would yield a sensor with the same operational characteristics as the 6+1 DOF solution except having one less translational degree-of-freedom and two fewer rotational degrees of freedom. Solutions for sensing displacement along a surface include optical and mechanical sensing components commonly found in pointing devices for computer systems.

The foregoing detailed description and appended drawings are intended as a description of the currently preferred embodiment of the invention and are not intended to represent the only forms in which the present invention may be constructed or utilized. Those skilled in the art will understand that strain gauges or other sensors capable of sensing compressive force may be added to provide compressive force feedback on multiple axes. Therefore, the invention is not limited to a spatial motion sensor having compressive force feedback along a single axis. Modifications and alternative embodiments of the present invention which do not depart from the spirit and scope of the foregoing specification and drawings, and of the claims appended below are possible and practical. It is intended that the claims cover all such modifications and alternative embodiments.

### INDUSTRIAL APPLICABILITY

This invention may be industrially applied to the development, manufacture, and use of motion- and force-sensing devices.

What is claimed is:

1. A probe providing six degree-of-freedom spatial tracking information and compressive force detection comprising:
at least three accelerometers, wherein each accelerometer provides translation information on one of three orthogonal axes;
at least three gyroscopes, wherein each gyroscope provides angular orientation information about one of the three orthogonal axes; and
at least one force detection sensor detecting compressive force along at least one translational axis.

2. The device of claim 1, further including a microcontroller, wherein the micro controller converts signals received from the at least three accelerometers, at least three gyroscopes and at least one force detection sensor into computer readable electrical quantities.

3. The device of claim 1, further including a compass working in combination with the gyroscopes to correct for rotational drift.

4. The device of claim 1, wherein the accelerometers, gyroscopes, compass and at least one force detection sensor are packaged within a handheld probe.

5. The device of claim 4, wherein the handheld probe is in the shape of an ultrasound transducer.

6. The device of claim 1, wherein the handheld probe contains an enclosure, the enclosure containing braces securing an electronic assembly comprising the at least three accelerometers, the at least three gyroscopes, and the at least one compressive force detection sensor.

7. The device of claim 1, wherein the degree of compression sensed by the compressive force sensor is used to proportionately deform computer simulated virtual tissue structures.

8. The device of claim 6, wherein the enclosure includes a soft tip that elastically deforms under compression, the compressive force detection sensor being located in the soft tip.

9. The device of claim 1, where each of the accelerometers is a MEMS accelerometer.

10. The device of claim 1, where each of the gyroscopes is a MEMS gyroscope.

11. The device of claim 3, wherein the compass is a MEMS compass.

12. The device of claim 1, where the force detection sensor is a strain gauge.

13. A probe providing six degree-of-freedom spatial tracking information and compressive force detection comprising:
at least three displacement sensors, wherein each displacement sensor provides displacement information on one of three orthogonal axes;
at least three orientation sensors, wherein each orientation sensor provides angular orientation information about one of the three orthogonal axes;
a compass working in conjunction with the orientation sensors to correct for rotational drift;
at least one force detection sensor detecting compressive force along at least one translational axis; and
a microcontroller, wherein the micro controller converts signals received from the displacement sensors, the orientation sensors, the compass, and the at least one force sensor into computer readable electrical quantities.

14. The device of claim 13, wherein the displacement sensors, the orientation sensors, the compass, and the at least one force detection sensor are packaged within a handheld probe.

15. The device of claim 14, wherein the handheld probe contains an enclosure, the enclosure containing braces securing an electronic assembly comprising the displacement sensors, the orientation sensors, the compass, and the at least one compressive force detection sensor.

16. The device of claim 15, wherein the enclosure includes a soft tip that elastically deforms under compression, the compressive force detection sensor being located in the soft tip.

17. The device of claim 13, further including driver software wherein the device's spatial location may be graphically displayed on virtual tissue structures simulated on a computer.

18. The device of claim 13, wherein the degree of compression sensed by the compressive force sensor proportionately deforms computer simulated virtual tissue structures.

19. The device of claim 13, wherein communication from the probe to a personal computer is achieved with a wired electrical connection.

20. The device of claim 13, wherein communication from the probe to a personal computer is achieved with a wireless connection.

21. A probe providing spatial tracking information and compressive force detection comprising:
an accelerometers, where the accelerometer provides translation information on a movement axis;
a gyroscope, where the gyroscope provides angular orientation information about an orthogonal axis, the orthogonal axis being orthogonal to the movement axis; and
a force detection sensor detecting compressive force along a translational axis;
wherein the accelerometer, gyroscope, and force detection sensor are packaged within a handheld probe.
